(19) United States
(12) Patent Application Publication
(10) Pub. No.: US 2011/0017391 A1
(43) Pub. Date: Jan. 27, 2011

(54) ADHESIVE TAPE JOINING METHOD AND ADHESIVE TAPE JOINING APPARATUS

(76) Inventors: Masayuki Yamamoto, Osaka (JP); Chouhei Okuno, Osaka (JP)

Correspondence Address: Cheng Law Group, PLLC, 1100 17th Street, N.W., Suite 503, Washington, DC, 20036, US

(21) Appl. No.: 12/829,511

(22) Filed: Jul. 2, 2010

(30) Foreign Application Priority Data
Jul. 27, 2009 (JP) 2009-174194

(51) Int. Cl. B29C 65/50; B32B 37/12

(52) U.S. Cl. 156/249; 156/379.6; 156/510

(57) ABSTRACT

A wafer holding table that suction-holds a wafer of a mount frame moves downward below a frame holding table when a joining roller passes over an exposed portion of an adhesive tape between the wafer W and the ring frame f. Here, the exposed portion of the adhesive tape inclines obliquely downward, thereby joining the adhesive tape to the mount frame.

### BACKGROUND OF THE INVENTION

1. Field of the Invention

This invention relates to adhesive tape joining method and apparatus to join a supporting adhesive tape over a semiconductor wafer and a ring frame to hold the semiconductor wafer on the ring frame.

2. Description of the Related Art

Typically, a circuit pattern with numerous components is formed on a surface of a semiconductor wafer (hereinafter simply referred to as a “wafer”), and then a protective tape is joined to the surface of the wafer for protection. Grinding or polishing is performed in a back grinding process to a rear face of the wafer having the protected surface, thereby obtaining the wafer having a desired thickness. The wafer is adhesively held on the ring frame via a supporting adhesive tape (dicing tape) for reinforcement of the wafer. Subsequently, the protective tape is separated from the thinned wafer, and the wafer is transferred to perform a dicing process. See Japanese Patent Publication No. H02-28347A.

The wafer held on the ring frame differs in its processing step in accordance with semiconductor chips to be manufactured. For instance, laser dicing is performed on the semiconductor chips for micromachining thereof. Here, when the dicing is performed on the surface of the wafer with a circuit pattern formed thereon, the circuit may be damaged due to heat. Thus, the rear face of the wafer need to be half-cut diced prior to back grinding. When each chip that is made through breaking of the half-cut wafer is mounted in a desired position, a collet sucks the surface of the chips for transportation. As a result, the adhesive tape and protective tape on the surface of the chip may be separated. Only the wafer with the adhesive tape separated therefrom is to be transferred to another step. Here, the adhesive tape is joined again to the rear face of the wafer, and the wafer is adhesively held on a new ring frame. Subsequently, the wafer is subject to breaking. That is, the wafer need to be transferred onto a new ring frame prior to breaking. See Japanese Patent Publication No. 2006-278630A.

Moreover, the rear face of the wafer may be cleaned with the wafer held on the ring frame in accordance with the semiconductor chips to be manufactured. In this case, breaking is also performed to the wafer after cleaning and drying treatments and thereafter transferring the wafer onto the ring frame.

The above conventional method, however, has the following problem. That is, the wafer need to be adhesively held on a different ring frame in back grinding and dicing treatments. Consequently, twice the number of the ring frame as the wafer to be treated need to be prepared, which leads to complicated operation and control.

The method may also be considered in which one ring frame transfers the wafer again. Here, each of the ring frame and the wafer has a small thickness, and thus an adhesive tape to be joined may contact an exposed surface of the adhesive tape via which the wafer is adhesively held on the ring frame. The adhesive tape to be separated cannot be separated readily under this state. Consequently, tension more than required is to be applied to the adhesive tape, which may lead to a problem to damage the wafer.

### SUMMARY OF THE INVENTION

This invention provides adhesive tape joining method and apparatus to secure transferring of a wafer to a ring frame with no damage on the wafer and to increase efficiency in operation of joining an adhesive tape.

Additional features of the invention will be set forth in the description which follows, and in part will be apparent from the description, or may be learned by practice of the invention.

This invention discloses an adhesive tape joining method for adhesively holding a semiconductor wafer on a ring frame via a supporting adhesive tape. The method includes the steps of joining a second adhesive tape to a rear face of a mount frame in which a first adhesive tape is joined over surfaces of the ring frame and the semiconductor wafer with a circuit pattern formed thereon while avoid contacting of exposed adhesive surfaces of adhesive tapes between the semiconductor wafer and the ring frame, and separating the first adhesive tape from the surface of the semiconductor wafer having the rear face with the second adhesive tape joined thereto.

According to the adhesive tape joining method of this embodiment, the second adhesive tape is joined to the mount frame, in which the first adhesive tape is joined over surfaces of the ring frame and rear face of the wafer with the circuit pattern formed thereon. Subsequently, the first adhesive tape on the surface of the wafer is separated. That is, the wafer may adhesively be held on the same ring frame in both of processing and dicing steps on the rear face of the wafer.

Moreover, this method may avoid contacting of the exposed adhesive surfaces of both adhesive tapes between the wafer and the ring frame upon joining of the second adhesive tape on the rear face of the wafer. Consequently, damages on the wafer due to adhesion of both the adhesive tapes may be suppressed upon separation of the first adhesive tape.

Moreover, the adhesion of both adhesive surfaces may be avoided in the step of joining the adhesive tape as following.

Both the adhesive tapes are prevented from adhering to each other by vertically moving a wafer holding table to mount and hold the semiconductor wafer away from a frame holding table to hold the ring frame relatively that are capable of lifting independently.

According to this method, moving of the wafer holding table away from the frame holding table may produce a gap between the first and second adhesive tapes. Consequently, the adhesive tapes may be prevented from contacting to each other.

Moreover, both the adhesive tapes may be prevented from adhering to each other by sucking the exposed adhesive surface of the first adhesive tape from a lower portion and by bending thereof.

According to this method, the exposed surface of the first adhesive tape may be sucked from the lower portion to bend downward. As a result, a gap may be produced between the first and second adhesive tapes.

Moreover, the first adhesive tape joined to the surface of the semiconductor wafer may be of ultraviolet curable type. Both the adhesive tapes may be prevented from adhering to each other by irradiating the exposed adhesive surface of the first adhesive tape with ultraviolet rays.

According to this method, polymerization reaction may be performed on the adhesive by irradiating the exposed surface of the first adhesive tape with ultraviolet rays. That is, the adhesive is cured to reduce adhesive force thereof. Consequently, both adhesive tapes may be prevented from adhering firmly, which leads to suppression of damages on the wafer upon separation of the first adhesive tape.

Moreover, any one of a ring plate, a seat, and a film may have at least one of contacting surfaces to the first adhesive tape that is subjected to poor adhesion processing, and may be arranged on the exposed adhesive surface of the first adhesive tape.

According to this method, the ring plate may be interposed between the first and second adhesive tapes, and thus the adhesive tapes may be prevented from contacting to each other.

In each of the foregoing embodiments, the semiconductor wafer may have a surface with a protective tape joined thereto. Moreover, each of the embodiments may include a step of separating the protective tape after separation of the first adhesive tape.

This invention also discloses an adhesive tape joining apparatus to adhesively hold a semiconductor wafer on a ring frame via a supporting adhesive tape, the apparatus including a wafer holding table, a frame holding table, a tape joining mechanism, and a tape separating mechanism. The wafer holding table mounts and holds the semiconductor wafer of a mount frame in which a first adhesive tape is joined over the ring frame and a surface of the semiconductor wafer with a circuit pattern formed thereon. The frame holding table mounts and holds the ring frame of the mount frame. The tape joining mechanism joins a second adhesive tape over a rear face of the semiconductor wafer and the ring frame with the semiconductor wafer and the ring frame being moved vertically by lifting at least one of the wafer holding table and the frame holding table. The tape separating mechanism separates the first adhesive tape from the surface of the semiconductor wafer with the first and second adhesive tapes being joined to the surface and the rear face thereof, respectively.

According to this configuration, the wafer holding table and frame holding table may be moved away from each other by driving thereof independently. That is, a gap may be produced between the first and second adhesive tapes upon joining of the second adhesive tape to the read face of the wafer. Consequently, the adhesive tapes may be prevented from contacting to each other.

This invention also discloses an adhesive tape joining apparatus to adhesively hold a semiconductor on a ring frame via a supporting adhesive tape, the apparatus including a holding table, a suction mechanism, a tape joining mechanism, and a tape separating mechanism. The holding table has a recess formed at an exposed portion of a first adhesive tape upon placing of a mount frame in which the first adhesive tape is joined over the ring frame and the semiconductor wafer with a circuit pattern formed thereon. The suction mechanism sucks the exposed portion of the first adhesive tape downward from the recess of the holding table. The tape joining mechanism joins a second adhesive tape over a rear face of the semiconductor wafer and the ring frame with the exposed surface of the first adhesive tape being sucked downward. The tape separating mechanism separates the first adhesive tape from the surface of the semiconductor wafer with the first and second adhesive tapes being joined to the surface and the rear face thereof, respectively.

According to this configuration, the exposed portion of the first adhesive tape on the recess of the holding table may be sucked downward. Consequently, the exposed portion may bend downward with this suction, which produces a gap between the first and second adhesive tapes.

This invention also discloses an adhesive tape joining apparatus to adhesively hold a semiconductor on a ring frame via a supporting adhesive tape, the apparatus including a holding table, an ultraviolet irradiation mechanism, a tape joining mechanism, and a tape separating mechanism. The holding table mounts and holds a mount frame in which a first adhesive tape is joined over the ring frame and a surface of the semiconductor wafer with a circuit pattern formed thereon. The ultraviolet irradiation mechanism irradiates with ultraviolet rays an adhesive surface of the first adhesive tape that is exposed between the semiconductor wafer and the ring frame. The tape joining mechanism joins a second adhesive tape to the adhesive surface of the first adhesive tape over a rear face of the semiconductor wafer and the ring frame with the exposed surface of the first adhesive tape being sucked from the lower position. The tape separating mechanism separates the first adhesive tape from the surface of the semiconductor wafer with the first and second adhesive tapes being joined to the surface and the rear face thereof, respectively.

With this configuration, ultraviolet rays may be applied to the exposed portion of the first adhesive tape, which leads to curing of the adhesive in the exposed portion and reduction in adhesive force thereof.

This invention also discloses an adhesive tape joining apparatus to adhesively hold a semiconductor on a ring frame via a supporting adhesive tape, the apparatus including a ring plate, a tape joining mechanism, and a tape separating mechanism. The ring plate is placed on an adhesive surface of a first adhesive tape that is exposed between the ring frame and the semiconductor wafer of a mount frame in which the first adhesive tape is joined over the ring frame and the semiconductor wafer with a circuit pattern formed thereon. The ring plate has at least one of contacting surfaces to the first adhesive tape that is subject to poor adhesion processing. The tape joining mechanism joins a second adhesive tape over a rear face of the semiconductor wafer and the ring frame. The tape separating mechanism separates the first adhesive tape from the surface of the semiconductor wafer with the first and second adhesive tapes being joined to the surface and the rear face thereof, respectively.

With this configuration, the second adhesive tape is joined to the rear face of the wafer with the ring plate on the exposed portion of the first adhesive tape, and thus the ring plate may avoid contacting of the adhesive tapes to each other.

This invention also discloses an adhesive tape joining apparatus to adhesively hold a semiconductor wafer on a ring frame via a supporting adhesive tape, the apparatus including a wafer holding table, a frame holding table, a heater, a tape joining mechanism, and a tape separating mechanism. The wafer holding table mounts and holds the semiconductor wafer of a mount frame in which a first adhesive tape of thermal foam is joined over the ring frame and a surface of the semiconductor wafer with a circuit pattern formed thereon. The frame holding table mounts and holds the ring frame of the mount frame. The heater heats the adhesive surface of the first adhesive tape that is exposed between the semiconductor wafer and the ring frame. The tape joining mechanism joins the second adhesive tape over a rear face of the semiconductor wafer and the ring frame. The tape separating mechanism separates the first adhesive tape from the surface of the semiconductor wafer with the first and second adhesive tapes being joined to the surface and the rear face thereof, respectively.

With this configuration, adhesive in the exposed portion of the first adhesive tape that is heated by the heater is foamed and expanded, which leads to reduction in adhesive force thereof. Consequently, the adhesive force in the adhesive tapes may be reduced, and damages on the wafer may be suppressed.

In each of the exemplary apparatus noted above, the semiconductor wafer may have a surface with a protective tape joined thereto. Moreover, each of the exemplary apparatus may include a protective tape separating mechanism to separate the protective tape from the surface of the semiconductor wafer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing a basic configuration of an adhesive tape joining apparatus.

FIG. 2 is a front view of a frame supply section.

FIG. 3 is a plan view of a first transport mechanism.

FIG. 4 is a front view of the first transport mechanism.

FIG. 5 is a plan view of an adhesive tape joining section.

FIG. 6 is a front view of the adhesive tape joining section.

FIG. 7 is a plan view of a reverse unit.

FIG. 8 is a front view of the reverse unit

FIG. 9 is a plan view of a tape separation unit and a second transport mechanism

FIG. 10 is a perspective view of a mount frame in a step of separating an adhesive tape.

FIG. 11 is a front view of a holding table according to Embodiment 1

FIGS. 12-13 are explanatory views each showing operation of the holding table according to Embodiment 1.

FIG. 14 is a front view of a holding table according to Embodiment 2.

FIG. 15 is an explanatory view showing operation of the holding table according to Embodiment 2.

FIG. 16 is a front view of a holding table according to Embodiment 3

FIG. 17 is a front view of a holding table according to one modification.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One embodiment of this invention will be described hereunder with reference to the drawings.

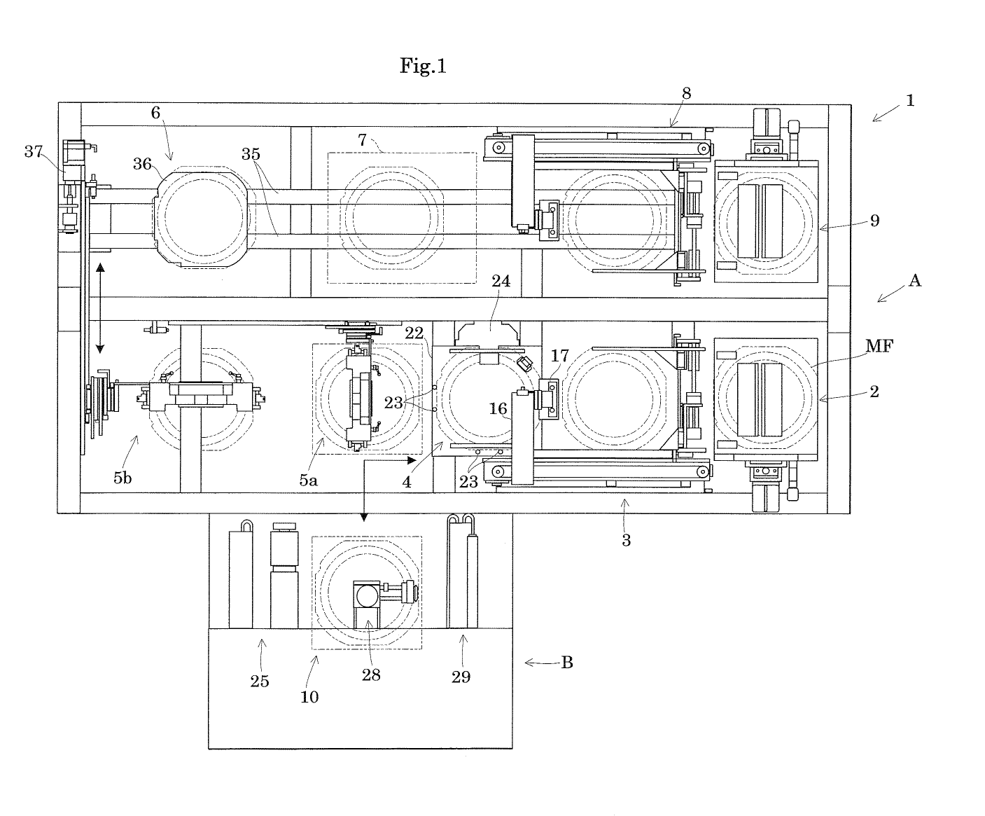

FIG. 1 is a plan view showing a basic configuration of an adhesive tape joining apparatus according to the one embodiment of this invention.

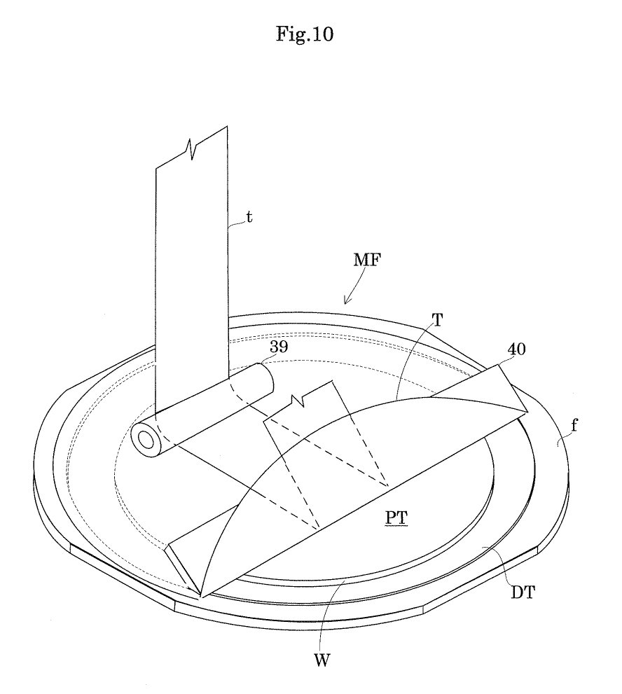

As shown in FIG. 10, the adhesive tape joining apparatus handles a mount frame MF. The mount frame MF is manufactured by joining an adhesive tape T to a ring frame f and a surface of a semiconductor wafer W (hereinafter, simply referred to as a “wafer W”) with a protective adhesive tape PT (hereinafter, simply referred to as a “protective tape PT”) joined thereto. The surface of the wafer W has a circuit pattern formed thereon. Specifically, a dicing adhesive tape DT is joined to a rear face of the wafer via the same mount frame MF, and subsequently the adhesive tape T and the protective tape PT are separated from the surface of the wafer W. Thereafter the wafer W is transported to perform a next dicing process with the circuit pattern formed thereon being exposed.

As shown in FIG. 1, the adhesive tape joining apparatus 1 has a laterally extending rectangular section A and a protrusion section B coupled on a center of the rectangular section A so as to protrude downward in plane. Here, in the following description, a longitudinal direction of the rectangular section A is defined as the horizontal direction. Moreover, a direction orthogonal to the horizontal direction is defined as upper and lower direction.

The rectangular section A has a frame supply section 2, a first transport mechanism 3, an aligner 4, and first and second inversion units 5a and 5b on the lower side thereof. The rectangular section A has a second transport mechanism 6 to transport the mount frame MF in the horizontal direction, a tape separation section 7, a third transport mechanism 8, and a frame collecting section 9 on the upper side thereof.

The protrusion section B has an adhesive tape joining section 10. Herein, the adhesive tape joining part 10 joins the adhesive tape DT to the ring frame f and the rear face of the wafer W.

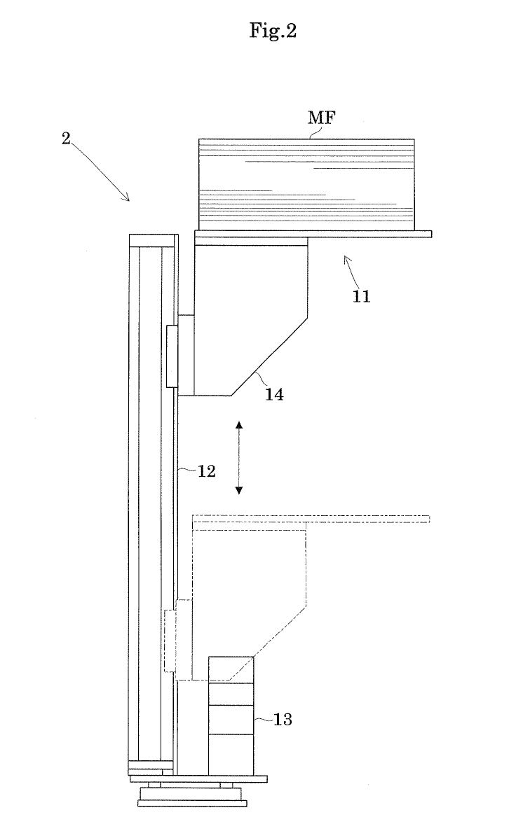

The frame supply unit 2 has a containing section 11. As shown in FIG. 2, the containing unit 11 collects the mount frame MF in a stack manner that adhesively holds the surface of the wafer W on the ring frame of FIG. 10 via the adhesive tape DT. Here, the surface of the wafer W with the circuit pattern is directed downward. The containing section 11 has an upright rail 12 and a lifting table 14. The upright rail 12 is fixedly coupled to an apparatus framework. The lifting table 14 moves upward and downward in a screw-feed manner by a motor 13 along the upright rail 12. Accordingly, the frame supply unit 2 allows the mount frame MF to be placed on the lifting table 14 so as to move upward and downward in a pitch feed manner.

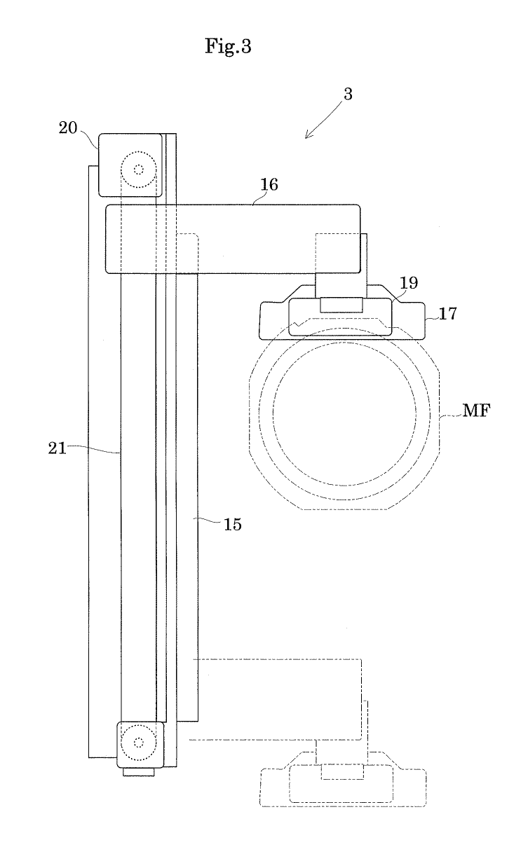

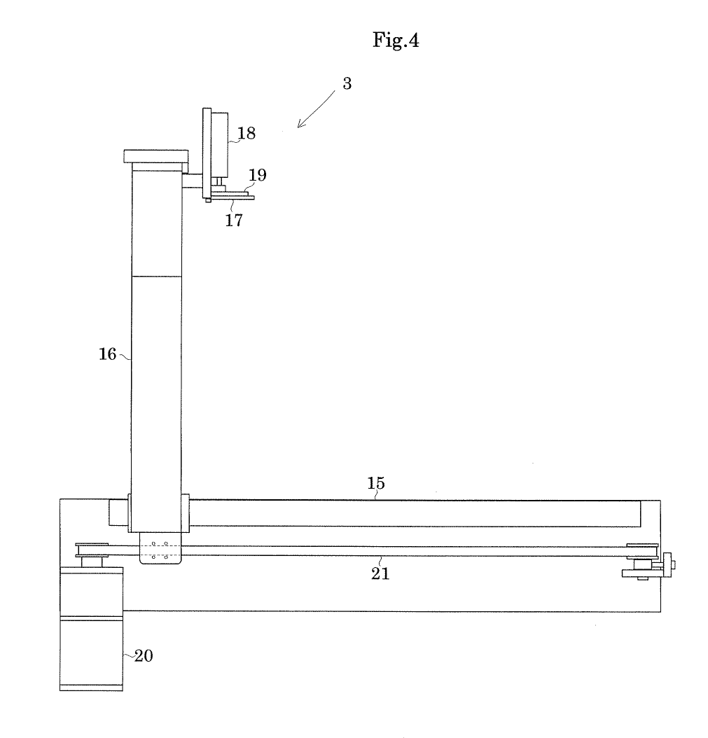

As shown in FIGS. 3 and 4, the first transport mechanism 3 has a chuck piece 19 provided on a movable table 16 that moves horizontally along a guide rail 15. A receiving piece 17 and a cylinder 18 open and close the chuck piece 19. Herein, the receiving piece 17 and chuck piece 19 vertically grasp one end of the mount frame MF. Moreover, the movable table 16 has a bottom side coupled to a belt 21 that is turned by a motor 20. That is, when the motor 20 operates forward and backward, the movable table 16 reciprocates in the horizontal direction.

Now referring to FIG. 1, the aligner 4 has a holding table 22, an alignment pin 23, and an alignment mechanism 24. The holding table 22 mounts the mount frame MF with the surface of the wafer W having the circuit pattern directed downward. The alignment pin 23 engages a notch formed at an outer periphery of the mount frame MF as an alignment position. The alignment mechanism 24 grasps the mount frame MF on both surfaces thereof vertically relative to plane of FIG. 1 for alignment.

The holding table 22 reciprocates between an alignment position in the aligner 4 and a tape joining position in the tape joining section 10 in the protrusion B while mounting and holding the mount frame MF.

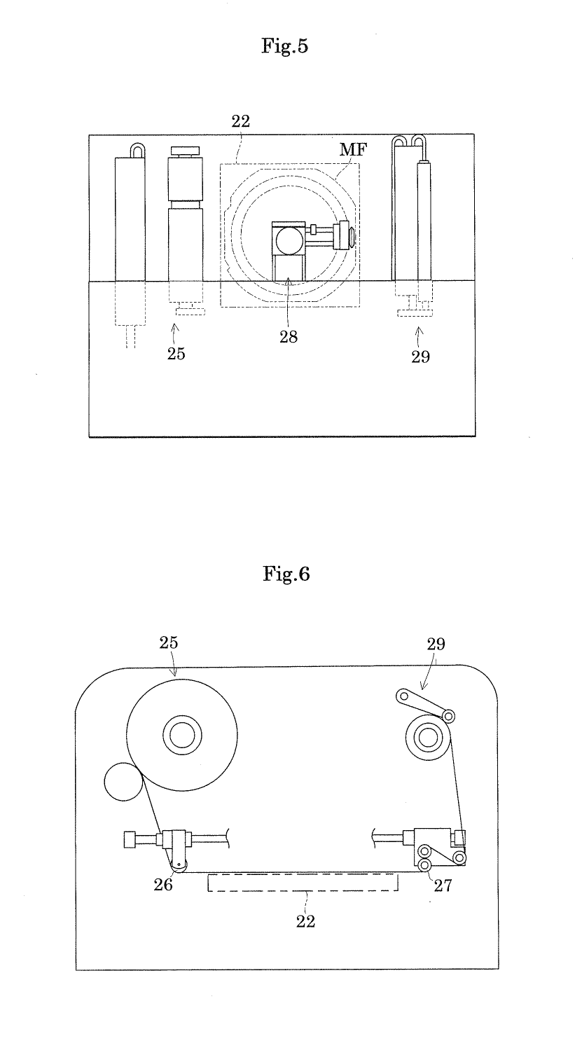

As shown in FIGS. 5 and 6, the adhesive tape joining section 10 has a tape supply unit 25, a joining roller 26, a separation roller 27, a tape cutting mechanism 28, and a tape collecting section 29. The tape supply section 25 houses a wide adhesive tape (a dicing tape) DT in a roll form. That is, the wafer W and the ring frame f that are placed on the holding table 22 reaches into the tape joining position with the rear face of the wafer W directed upward, and thereafter the joining roller 26 moves from right to left in FIG. 6. Thus, the adhesive tape DT is joined over the wafer W and ring frame f. Next, a disk blade turns with the tape cutting mechanism 28 having moved downward, and cuts the adhesive tape DT along the ring frame f. Next, the separation roller 27 moves from right to left in FIG. 6 to separate an unnecessary portion of the cut adhesive tape DT, which remains outside a cutting line thereof, from the ring frame f. Next, the tape collecting section 29 winds up and collects the separated unnecessary tape.

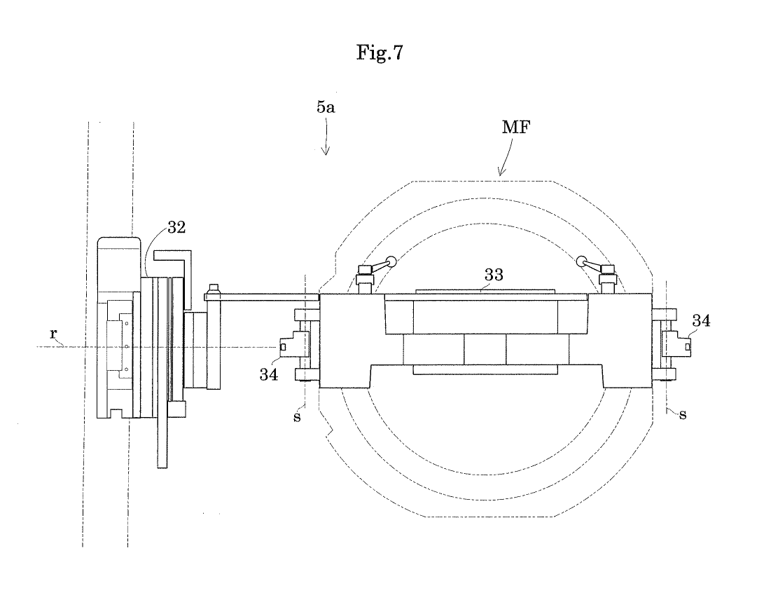

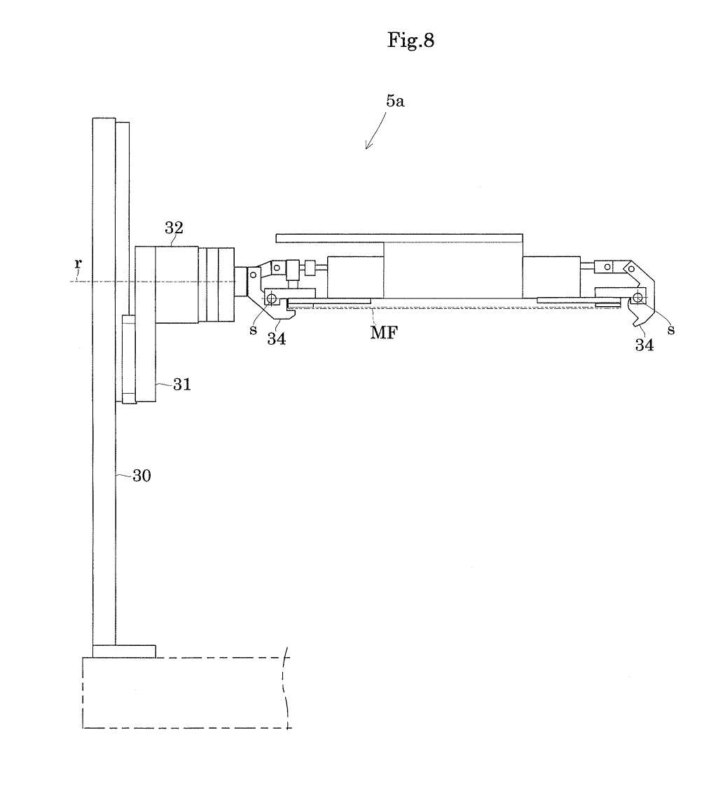

The first inversion unit 5a has the same configuration as the second inversion unit 5b. As shown in FIGS. 7 and 8, the inversion units 5a and 5b are provided on a lifting table 31 capable of lifting along the upright rail 30 that is fixedly erected. Moreover, the inversion units 5a and 5b have a receiving frame 33 attached in a cantilever manner. The receiving frame 33 may rotate about a horizontal axis r by means of a rotation actuator 32. Moreover, the inversion units 5a and 5b have chuck claws 34 at distal and proximal ends of the receiving frame 33, respectively, so as to rotate about an axis s.

The first inversion unit 5a horizontally moves from a receiving position and a transport position. At the receiving position, the first inversion unit 5a receives the mount frame MF from the holding table 22 that reciprocates between the aligner 4 and the tape joining section 10. At the transport position, the first inversion unit 5a transports the mount frame MF to the second inversion unit 5b.

The second inversion unit 5b moves horizontally from the transport position where the first inversion unit 5a transports the mount frame MF to a transport position where the second inversion unit 5b transports the mount frame MF to the second transport mechanism 6.

The second transport mechanism has a movable table 36 capable of moving horizontally along two guide rails 35 arranged in parallel in the horizontal direction in an upper side of FIG. 1. The movable table 36 has a table to suck the rear face of the mount frame MF reversed by the second inversion unit 5b. Moreover, the movable table 36 has a lower portion coupled to a belt moved rotationally by a motor 37. Accordingly, when the motor 37 operates forward and backward, the movable table 36 reciprocates in the horizontal direction.

A third transport mechanism 8 has the same configuration as the first transport mechanism 3. As shown in FIGS. 3 and 4, the third transport mechanism 8 has the chuck piece 19 provided on the movable table 16 that moves horizontally in the horizontal direction along a guide rail 15. The receiving piece 17 and cylinder 18 open the chuck piece 19. Herein, the receiving piece 17 and the chuck piece 19 vertically grasp one end of the mount frame MF. Moreover, the movable board 16 has a bottom coupled to a belt 21 moved rotationally by the motor 20. Accordingly, when the movable table 16 moves forward/backward, the movable table 16 reciprocates in the horizontal direction.

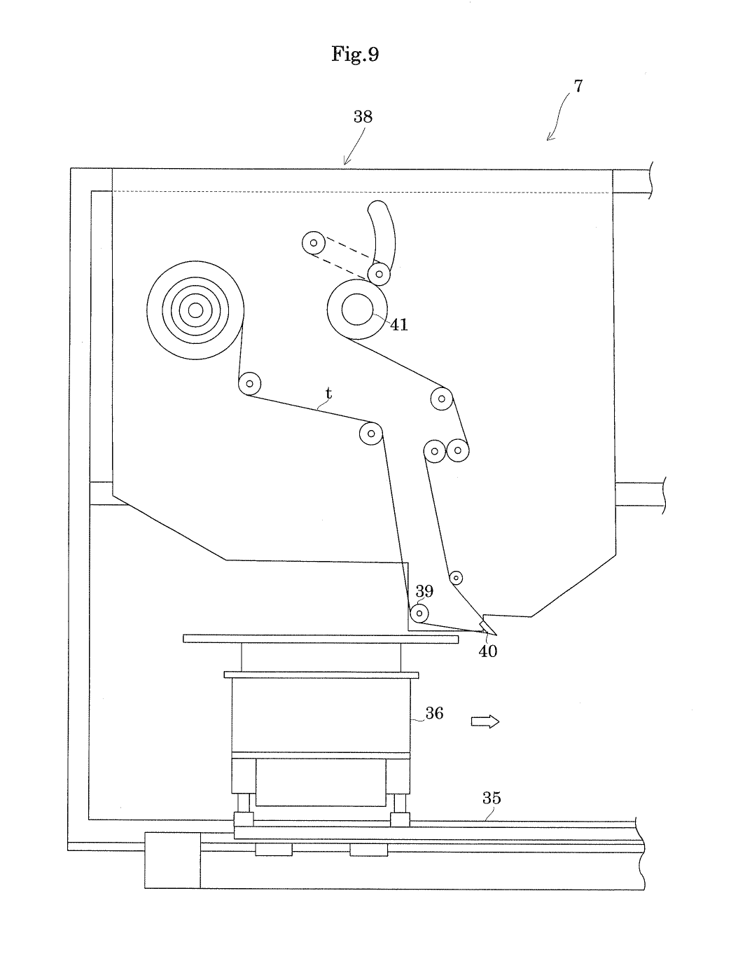

As shown in FIG. 9, the tape separation section 7 has a tape separation unit 38. The tape separation unit 38 has the following configuration. That is, a guide roller 39 guides a narrow separation tape t in a roll form to a knife edge-shaped separation bar 40. The separation bar 40 folds back the separation tape t, and thereafter, a winding shaft 41 winds up and collects the separation tape t. Specifically, the separation tape t is joined to the adhesive tape T on the surface of the wafer in the mount frame MF that is suction-held on the movable table 36 serving as a holding table. In this state, the movable table 36 moves to the right in plane of FIG. 9. Consequently, the separation tape t is folded back at a tip end of the separation bar 40, so that the protective tape PT is separated via the adhesive tape T together with the separation tape t from the surface of the wafer W.

The frame collecting section 9 has the same configuration as the frame supply section 2. As shown in FIG. 2, the frame collecting section has the containing section 11. Herein, the containing section 11 collects the mount frame MF in a stack manner that is manufactured by joining the adhesive tape DT to the ring frame f and the wafer W such that the ring frame f holds the wafer W. The containing section 11 includes the upright rail 12 fixedly coupled to the apparatus framework, and the lifting table 14 driven by the motor 13 so as to move vertically in a screw feed manner along the upright rail 41. Accordingly, the ring frame supply section 2 allows the mount frame MF placed on the lifting table 14 to move vertically in a pitch feed manner.

Description will be given next of basic operation for joining the adhesive tape to the rear face of the wafer W according to the apparatus in the foregoing exemplary embodiment.

In this basic operation, description will be given of the adhesive tape joining processes after cleaning the rear face of the wafer W. Here, the mount frame MF is manufactured by joining the adhesive tape T to the ring frame f and the surface of the wafer W having the protective tape PT joined thereto.

The first transport mechanism 3 holds the mount frame MF housed in the frame supply section 2 in a stack manner with the surface of the wafer W directed downward. Thereafter, the first transport mechanism 3 moves and mounts the mount frame MF on the holding table 22 of the aligner 4. The mount frame MF is aligned on the holding table 22, and then transported to the tape joining section 10 while being held on the holding table 22.

When the holding table 22 reaches into the transport position, the joining roller 26 in FIG. 6 moves downward to roll on the adhesive tape DT from right to left in plane of FIG. 6. Consequently, the adhesive tape DT is joined to the rear face of the mount frame MF. When the joining roller 26 reaches into its termination position, the tape cutting mechanism 28 moves downward to cut the adhesive tape DT while turning the cutter blade along the ring frame f.

Upon completion of cutting the adhesive tape DT, the tape cutting mechanism 28 moves upward, and the separation roller 27 moves from right to left in plane of FIG. 6, thereby winding up and collecting the unnecessary adhesive tape after cut out.

Upon completion of joining the adhesive tape DT to the mount frame MF, the holding table 22 moves to the rectangular section A and then stops. Here, the first inversion unit 5a sucks the mount frame MF to transport to the second inversion unit 5b. At this time, the wafer W is still held with the rear face thereof directed upward. The second inversion unit 5b that receives the mount frame MF is reversed upside down, and transports the mount frame MF to the movable table 36 of the second transport mechanism 6 with the surface of the wafer W having the circuit pattern directed upward.

The movable table 36 moves to the tape separation section 7 while suction-holding the mount frame MF. When the movable table 36 reaches the tape separation section 7, the tape separation unit 38 operates to move the separation bar 40 downward into an adhesive tape joining start position of the mount frame MF. The separation bar 40 presses to join the separation tape t to the adhesive tape T, and thereafter the movable table 36 moves. The winding shaft 41 winds up the separation tape t in synchronization with the movement of the movable table 36. Consequently, as shown in FIG. 10, the adhesive tape T is separated from the surface of the protective tape PT together with the separation tape t.

Upon separation of the adhesive tape T from the mount frame MF, the separation bar 40 moves upward to return to its standby position. Simultaneously, the movable table 36 moves to a separation starting position of the protective tape PT. When the movable table 36 reaches the separation starting position, the separation bar 40 moves downward to join the separation tape t to an end where the protective tape PT starts to be separated. Thereafter, the movable table 36 moves in the same direction as the separation tape T previously separated. The winding shaft 41 winds up the separation tape t in synchronization with the movement of the movable table 36. Consequently, the protective tape PT is separated from the surface of the wafer W together with the separation tape t.

Upon separation of the protective tape PT from the surface of the wafer W, the movable table 36 moves to a standby position of the third transport mechanism 8. The movable table 36 releases suction of the mount frame MF at the standby position. Simultaneously, the chuck piece 19 in the third transport mechanism 8 suction-holds the mount frame MF to transport the mount frame MF to the frame collecting section 9.

Thus, a round of the basic operation is completed as mentioned above. The similar operation is to be repeated hereinafter.

In the foregoing exemplary embodiment, the wafer W having the rear face with the half-cut for dicing performed thereon in advance may be processed in the same procedure. Moreover, the mount frame MF, in which the adhesive tape T is joined over the wafer W and the ring frame f, may be handled similarly in cleaning and half-cut of the rear face of the wafer W with the protective tape PT separated in advance from the surface of the wafer W. In this case, merely the step of separating the protective tape PT may be omitted from the above operation.

Next, description will be given to each exemplary embodiment with the apparatus noted above.

### Embodiment 1

In this exemplary embodiment, the holding table 22 of the aligner 4 differs from the foregoing embodiments. Specific configuration thereof will be described hereinafter.

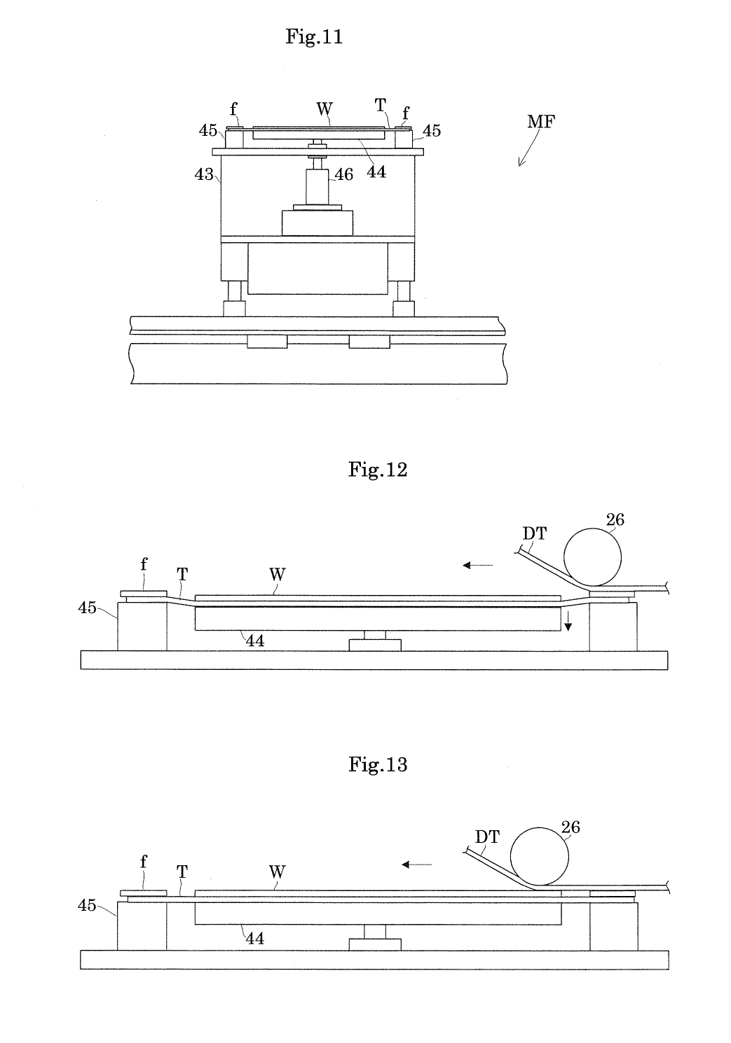

As shown in FIG. 11, the holding table 22 has a wafer holding table 44 and a frame holding table 45 to hold the ring frame f. The wafer holding table 44 suction-holds the wafer W on a movable table 43. The movable table 43 that moves along a transportation path shown in FIG. 1 from a position where the aligner 4 aligns the mount frame MF to the tape joining position in the tape joining section 10 where the adhesive tape DT is joined.

An actuator 46 may lift the wafer holding table 44. The actuator 46 is provided in the movable table 43. That is, the wafer holding table 46 is configured so as to change a surface level of the wafer W.

Next, operation of the apparatus in this Embodiment will be described. This Embodiment differs from the foregoing basic operation in joining process in the tape joining section 10. Thus, the different operation is to be described.

When the aligned mount frame MF reaches into the tape joining section 10, the wafer holding table 44 slightly moves downward while suction-holding the ring frame f and the wafer W, as shown in FIG. 12. Here, the exposed portion of the adhesive tape T inclines obliquely downward from the inner diameter of the ring frame f toward the outer periphery of the wafer. In this state, the joining roller 26 rolls to join the adhesive tape DT to the mount frame MF.

In the step of joining the adhesive tape DT, the wafer holding table 44 moves upward as the joining roller 26 approaches the outer periphery of the wafer. That is, upon reaching of the joining roller 26 to the outer periphery of the wafer, the level of the tape joined surface of the wafer is controlled so as to be identical to that of the ring frame f, as shown in FIG. 13.

Moreover, the wafer holding table 44 moves downward again as the joining roller 26 approaches the joining termination position of the adhesive tape DT on the wafer W, as shown in FIG. 12. When the joining roller reaches into an end of the ring frame f where joining of the adhesive tape DT terminates, the wafer holding table 44 moves upward so as to return the wafer into the same level as the ring frame f.

The level of the holding table 44 may be controlled in accordance with a moving distance of the joining roller 26 detected by a sensor, such as an encoder. Moreover, a lifting speed and level of the wafer holding table 44 may be controlled based on the moving distance and speed of the joining roller 26 determined in advance.

Upon completion of joining the adhesive tape DT, the tape cutting mechanism 28 cuts the adhesive tape DT along the ring frame f and the separation roller 27 winds up and collects the unnecessary tape while separating, as shown in FIGS. 5 and 6. Thereafter, each of the joining roller 26 and separation roller 27 returns to its initial position.

According to this configuration, the wafer holding table 44 moves downward when the joining roller 26 passes over the exposed portion of the adhesive tape T between the wafer W and the ring frame f. Here, the exposed portion of the adhesive tape T inclines obliquely downward from the inner diameter of the ring frame f toward the outer periphery of the wafer. Consequently, a distance increases between a rolling surface of the joining roller 26 and the adhesive tape T. Therefore, even when the joining roller 26 pushes the adhesive tape DT into the gap or slack of the adhesive tape DT occurs upon joining of the adhesive tape, the adhesive tape DT may be prevented from contacting to the adhesive tape T on the lower side that faces to each other.

In this configuration, when the adhesive tape DT tends to be joined to the adhesive tape T around the tape joining starting end and fails to be joined around the tape joining termination end due to a thickness of the wafer or other setting conditions, the wafer W need not to be moved downward to the tape joining termination end.

### Embodiment 2

This Embodiment differs from Embodiment 1 in the configuration of the holding table 22 of the aligner 4. The specific configuration thereof is to be described.

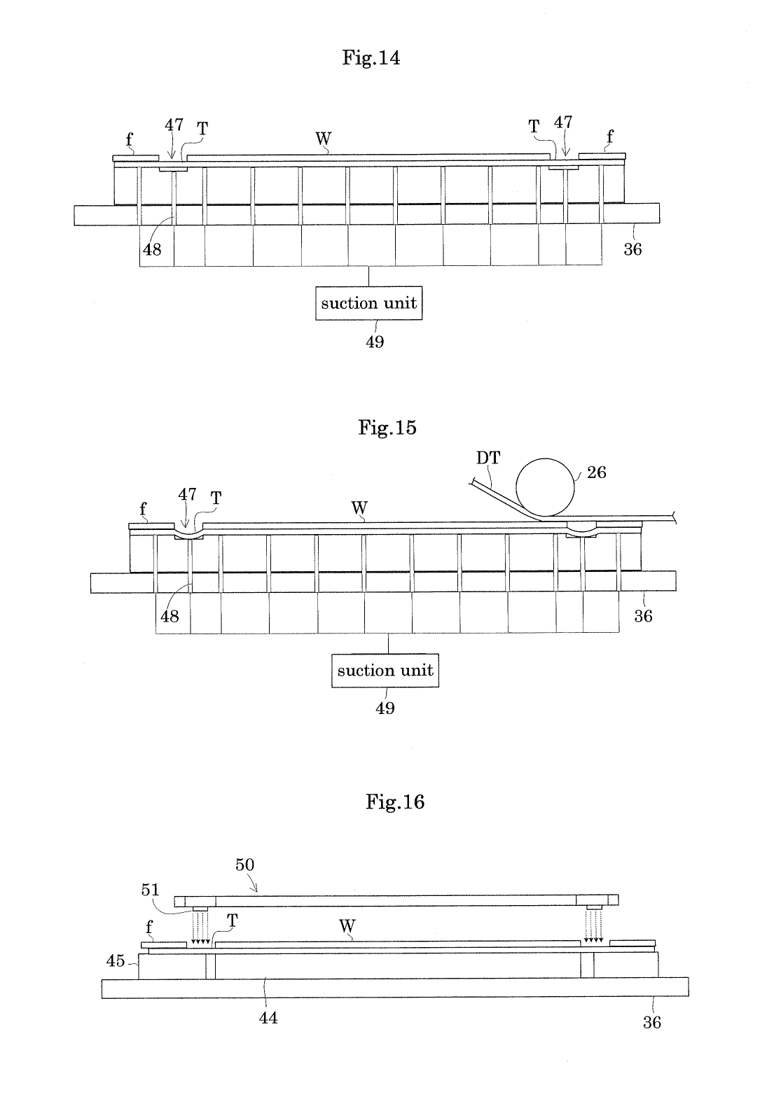

As shown in FIG. 14, the holding table 22 has an annular groove 47 at the exposed portion of the adhesive tape T. Suction holes 48 are formed in the groove 47 that is communicated to a suction unit 49. Here, the groove 47 corresponds to the recess of this invention, and the suction unit 49 to the suction mechanism.

As shown in FIGS. 11 to 13, the holding table 22 may be divided into the wafer holding table 44 to hold the wafer W, and the frame holding table 45 to hold the ring frame f. In this case, one of the holding tables may cover the exposed surface of the adhesive tape T and the groove 47 for suction may be provided under the holding table.

Next, operation of the apparatus in this embodiment will be described. This Embodiment differs from the foregoing basic operation in joining process in the tape joining section 10. Thus, the different operation is to be described.

When the aligned mount frame MF reaches into the tape joining section 10, the suction unit 49 firstly operates. Here, as shown in FIG. 15, the adhesive tape T is drawn into the groove 47 and bends along the groove 47. The joining roller 26 moves downward and rolls from the joining starting position to the joining termination position under this state, thereby joining the adhesive tape DT to the mount frame MF.

Upon completion of joining the adhesive tape DT, the tape cutting mechanism 28 cuts the adhesive tape DT along the ring frame f and the separation roller 27 winds up and collects the unnecessary tape while separating, as shown in FIGS. 5 and 6. Thereafter, each of the joining roller 26 and separation roller 27 returns to its initial position, and the suction unit 49 stops suction on the groove 47.

According to this configuration, when the adhesive tape DT is joined over the ring frame f and the wafer W with the rear face thereof directed downward, the adhesive tape DT may be prevented from contacting to the adhesive tape T on the lower side that faces to each other even if the joining roller 26 pushes the adhesive tape DT into the gap between the wafer W and the ring frame f where the adhesive tape T is exposed. That is, the exposed portion of the adhesive tape T is drawn into the groove 47 of the frame holding table 45, and thus a distance increases from the level of joining the adhesive tape DT to the adhesive tape T. Consequently, contact of the adhesive tape T and the adhesive tape DT may be avoided at the exposed portion.

### Embodiment 3

In this exemplary embodiment, the adhesive tape T to be joined to a surface of a wafer W is of an ultraviolet curable type. Moreover, as shown in FIG. 16, an ultraviolet irradiation mechanism 50 is arranged above the aligner 4 in the foregoing exemplary embodiments.

The ultraviolet irradiation mechanism 50 is capable of lifting from a standby position above the aligner 4 to an irradiation position therebelow where ultraviolet rays are applied. That is, the ultraviolet irradiation mechanism 50 is set to standby in a position not to interrupt a path for transporting the mount frame MF when the first transport mechanism 3 transports the mount frame MF to the aligner 4.

The ultraviolet irradiation mechanism 50 has a contour appropriately same as the ring frame f. Ultraviolet emitting diodes 51 are arranged so as to face to the exposed portion of the adhesive tape T between the ring frame f and the wafer W. That is, the ultraviolet emitting diodes 51 are circularly placed along the exposed portion of the adhesive tape T.

According to this configuration, the aligner 4 completes alignment of the wafer W, and thereafter the ultraviolet irradiation mechanism 50 moves downward to a fixed level to locally irradiate the exposed portion of the adhesive tape T with ultraviolet rays. Polymerization reaction on the adhesive may be promoted by the irradiation with ultraviolet rays, and thus the adhesive may be cured. Consequently, the adhesive force in the adhesive tape T may be reduced. Accordingly, even if the joining roller 26 pushes the adhesive tape DT to contact to the adhesive tape T upon joining of the adhesive tape DT in the tape joining section 10, adhesive surfaces of the adhesive tapes DT and T may be prevented from joining to each other firmly. As a result, no excessive tension is applied on the wafer W upon separation of the adhesive tape T, and damages on the wafer W may be suppressed.

In addition to the foregoing embodiments, this invention may be embodied variously as follows.

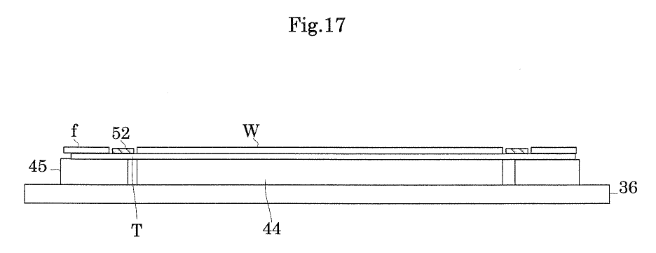

In the foregoing exemplary embodiments, the adhesive tape DT may be joined to the mount frame MF with an annular plate 52 placed on the exposed portion of the adhesive tape T, as shown in FIG. 17. The annular plate 52 may have a surface subjected to a release treatment so as to separate the adhesive tape DT readily upon contacting thereto. In addition, the annular plate 52 is not limited to a plate, but may be a sheet or film. The annular plate 52 of a sheet or film may be separated together with the adhesive tape T from the mount frame MF upon separation of the adhesive tape T.

According to this configuration, even when the adhesive tape DT is pushed into the exposed portion of the adhesive tape T, contacting of the adhesive tape DT to the adhesive tape T may be completely suppressed.

In Embodiment 1, the holding table 44 is capable of lifting. Here, the frame holding table 45 may move vertically. Both of the holding tables 44 and 45 may lift relatively so as to separate from each other.

In Embodiment 3, the ultraviolet irradiation mechanism 50 may be an ultraviolet lamp that uses ultraviolet light emitting diodes.

In Embodiment 3, the ultraviolet curable adhesive tape T is adopted. An adhesive tape of thermal foam may be adopted. In this case, instead of the ultraviolet irradiation mechanism 50 above the aligner 4, an annular heat plate containing a heater that is housed in the exposed portion of the adhesive tape T may approach or contact to an adhesive surface thereof so as to heat only the exposed portion of the adhesive tape T.

In this configuration, the adhesive in the exposed portion of the adhesive tape T has adhesive force reduced due to thermal foaming. Therefore, the adhesive tape T may be prevented from being joined firmly even in contacting to the adhesive tape DT.

In each of the foregoing embodiments, where an ultraviolet curable adhesive tape T is adopted as the adhesive tape T, the ultraviolet irradiation unit is preferably placed in front of the tape separation section 7 so as to separate the adhesive tape T readily. The ultraviolet irradiation unit may have a cover to cover the mount frame MF, and an ultraviolet lamp. The ultraviolet irradiation unit is capable of lifting between the ultraviolet irradiation position and the standby position thereabove.

That is, upon irradiation with ultraviolet rays, the cover moves downward to seal the mount frame MF with the movable table 43. Under this state, nitrogen is purged inside, and then the adhesive tape T is irradiated with ultraviolet rays.

The ultraviolet irradiation unit is not limited to this aspect. For instance, the ultraviolet irradiation unit may have a surface including a portion with ultraviolet light emitting diodes arranged thereon, the surface facing to the ultraviolet irradiation area. Moreover, ultraviolet light emitting diodes may be arranged in one-dimensional array along the radial direction of the mount frame MF.

Where an ultraviolet irradiation unit is used in which ultraviolet light emitting diodes are arranged in one-dimensional array, the holding tables 44 and 45 that hold the mount frame MF may turn together while controlling the turning speed thereof so as to obtain a uniform accumulated quantity of ultraviolet rays over the surface of the adhesive tape T.

In each of the foregoing embodiments, where the adhesive tape of thermal foam is adopted, a heating mechanism is provided on or in front of the tape separating section 7 for heating the adhesive tape T. That is, a plate with a heater contained therein that has a larger size than the contour of the protective tape T may be configured so as to lift between an operation position where the plate contacts the adhesive tape T and a standby position thereabove.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An adhesive tape joining method for adhesively holding a semiconductor wafer on a ring frame via a supporting adhesive tape, comprising the steps of:
joining a second adhesive tape to a rear face of a mount frame in which a first adhesive tape is joined over surfaces of the ring frame and the semiconductor wafer with a circuit pattern formed thereon while avoid contacting of exposed adhesive surfaces of adhesive tapes between the semiconductor wafer and the ring frame; and
separating the first adhesive tape from the surface of the semiconductor wafer having the rear face with the second adhesive tape joined thereto.

2. The adhesive tape joining method according to claim 1, wherein
in the step of joining the second adhesive tape, both of the adhesive tapes are prevented from adhering to each other by vertically moving a wafer holding table to mount and hold the semiconductor wafer away from a frame holding table to hold the ring frame relatively that are capable of lifting independently.

3. The adhesive tape joining method according to claim 1, wherein
in the step of joining the second adhesive tape, both of the adhesive tapes are prevented from adhering to each other by sucking the exposed adhesive surface of the first adhesive tape from a lower portion and by bending thereof.

4. The adhesive tape joining method according to claim 1, wherein
the first adhesive tape joined to the surface of the semiconductor wafer is of ultraviolet curable type, and in the step of joining the second adhesive tape, both the adhesive tapes are prevented from adhering to each other by irradiating the exposed adhesive surface of the first adhesive tape with ultraviolet rays.

5. The adhesive tape joining method according to claim 1, wherein
in the step of joining the second adhesive tape, any one of a ring plate, a seat, and a film has at least one of contacting surfaces to the first adhesive tape that is subjected to poor adhesion processing, and is arranged on the exposed adhesive surface of the first adhesive tape.

6. The adhesive tape joining method according to claim 5, wherein
in the step of separating the first adhesive tape, the first adhesive tape is separated together with one of the sheet and the film by joining the separation tape to one of the sheet and the film arranged on the exposed adhesive surface of the first adhesive tape, and then separating the separation tape.

7. The adhesive tape joining method according to claim 1, further comprising the step of
separating a protective tape joined to the surface of the semiconductor wafer after separation of the first adhesive tape.

8. An adhesive tape joining apparatus to adhesively hold a semiconductor wafer on a ring frame via a supporting adhesive tape, comprising:
a wafer holding table to mount and hold the semiconductor wafer of a mount frame in which a first adhesive tape is joined over the ring frame and a surface of the semiconductor wafer with a circuit pattern formed thereon;
a frame holding table to mount and hold the ring frame of the mount frame;
a tape joining mechanism to join a second adhesive tape over a rear face of the semiconductor wafer and the ring frame with the semiconductor wafer and the ring frame being moved away vertically by lifting at least one of the wafer holding table and the frame holding table; and
a tape separating mechanism to separate the first adhesive tape from the surface of the semiconductor wafer with the first and second adhesive tapes being joined to the surface and the rear face thereof, respectively.

9. The adhesive tape joining apparatus according to claim 8, further comprising:
a protective tape separating mechanism to separate the protective tape from the surface of the semiconductor.

10. An adhesive tape joining apparatus to adhesively hold a semiconductor on a ring frame via a supporting adhesive tape, comprising:
a frame holding table having a recess formed at an exposed portion of a first adhesive tape upon placing of a mount frame in which the first adhesive tape is joined over the ring frame and the semiconductor wafer with a circuit pattern formed thereon;
a suction mechanism to suck the exposed portion of the first adhesive tape downward from the recess of the holding table;
a tape joining mechanism to join a second adhesive tape over a rear face of the semiconductor wafer and the ring frame with the exposed surface of the first adhesive tape being sucked downward; and
a tape separating mechanism to separate the first adhesive tape from the surface of the semiconductor wafer with the first and second adhesive tapes being joined to the surface and the rear face thereof, respectively.

11. The adhesive tape joining apparatus according to claim 10, further comprising:
a protective tape separating mechanism to separate the protective tape from the surface of the semiconductor.

12. An adhesive tape joining apparatus to adhesively hold a semiconductor on a ring frame via a supporting adhesive tape, comprising:
a frame holding table to mount and hold a mount frame in which a first adhesive tape is joined over the ring frame and a surface of the semiconductor wafer with a circuit pattern formed thereon;
an ultraviolet irradiation mechanism to irradiate with ultraviolet rays an adhesive surface of the first adhesive tape that is exposed between the semiconductor wafer and the ring frame;
a tape joining mechanism to join a second adhesive tape to a rear face of the semiconductor wafer and the ring frame; and
a tape separating mechanism to separate the first adhesive tape from the surface of the semiconductor wafer with the first and second adhesive tapes being joined to the surface and the rear face thereof, respectively.

13. The adhesive tape joining apparatus according to claim 12, further comprising:
a protective tape separating mechanism to separate the protective tape from the surface of the semiconductor.

14. An adhesive tape joining apparatus to adhesively hold a semiconductor on a ring frame via a supporting adhesive tape, comprising:
a ring plate that is placed on an adhesive surface of a first adhesive tape that is exposed between the ring frame and the semiconductor wafer of a mount frame in which the first adhesive tape is joined over the ring frame and the semiconductor wafer with a circuit pattern formed thereon and that has at least one of contacting surfaces to the first adhesive tape that is subject to poor adhesion processing;
a tape joining mechanism to join a second adhesive tape over a rear face of the semiconductor wafer and the ring frame; and
a tape separating mechanism to separate the first adhesive tape from the surface of the semiconductor wafer with the first and second adhesive tapes being joined to the surface and the rear face thereof, respectively.

15. The adhesive tape joining apparatus according to claim 14, further comprising:
a protective tape separating mechanism to separate the protective tape from the surface of the semiconductor.

16. An adhesive tape joining apparatus to adhesively hold a semiconductor wafer on a ring frame via a supporting adhesive tape, comprising:
a wafer holding table to mount and hold the semiconductor wafer of a mount frame in which a first adhesive tape of thermal foam is joined over the ring frame and a surface of the semiconductor wafer with a circuit pattern formed thereon;
a frame holding table to mount and hold the ring frame of the mount frame;
a heater to heat the adhesive surface of the first adhesive tape that is exposed between the semiconductor wafer and the ring frame;
a tape joining mechanism to join the second adhesive tape over a rear face of the semiconductor wafer and the ring frame; and
a tape separating mechanism to separates the first adhesive tape from the surface of the semiconductor wafer with the first and second adhesive tapes being joined to the surface and the rear face thereof, respectively.

17. The adhesive tape joining apparatus according to claim 16, further comprising:
a protective tape separating mechanism to separate the protective tape from the surface of the semiconductor.
